(19) United States
(12) Patent Application Publication
(10) Pub. No.: US 2012/0070010 A1
(43) Pub. Date: Mar. 22, 2012

(54) ELECTRONIC DEVICE FOR DETECTING WHITE NOISE DISRUPTIONS AND A METHOD FOR ITS USE

(76) Inventor: Larry Odien, Saugus, CA (US)

(21) Appl. No.: 13/070,470

(22) Filed: Mar. 23, 2011

Related U.S. Application Data
(60) Provisional application No. 61/316,474, filed on Mar. 23, 2010.

(51) Int. Cl. H04R 29/00

(52) U.S. Cl. 381/58

(57) ABSTRACT

The present device is an audio detection system for detecting irregularities in white noise levels. This system works by first amplifying an audio input signal and determining a baseline. A detecting unit within the system then detects audio levels at, above or below the baseline level and signals a visual output device allowing a user to view this information. In one embodiment, multiple audio detection systems can be used together or combined into a single instrument to determine if irregularities in white noise levels are occurring in a particular place or direction. In another embodiment, the audio detection system can comprise a white noise generator.

### CROSS REFERENCE TO RELATED APPLICATIONS

The application claims benefit to provisional patent application No. 61/316,474, which is incorporated by reference herein in its entirety.

### FIELD OF THE INVENTION

The present device detects and measures audio signal data, particularly; it detects and measures irregularities in white noise levels. In an alternative embodiment, the present device can also be used to detect the direction from which the irregularities in white noise levels are emanating.

### BACKGROUND

Many have come to believe that paranormal beings have the ability to manipulate electromagnetic forces. Furthermore, many have come to believe that these manipulations can be detected as irregularities in white noise. White noise is a signal containing equal power within a fixed bandwidth at any center frequency. Therefore, a need has arisen for detecting irregularities in white noise. In particular, a device is needed, which can amplify white noise and use the amplified signal to set a baseline. This device must also be capable of detecting and indicating to a user audio signals that are both above and below the set baseline. Furthermore, a device is needed that can detect the direction from which the irregularities in white noise are coming.

### SUMMARY OF THE INVENTION

It is an aspect of the present device to provide an audio detection system capable of detecting and measuring irregularities in white noise levels. This aspect can be obtained by an audio detection system comprising an audio input device, an amplifying unit comprising a potentiometer configured to set a baseline, a detecting unit configured to detect audio input above the baseline and audio input below the baseline, and a visual output device configured to display a baseline and audio input above the baseline and audio input below the baseline.

It is a further aspect of the present device to provide an audio detection system capable of detecting the direction from which irregularities in white noise levels are emanating. This aspect can be obtained by an audio detection device, comprising a first component comprising a first microphone connected to a first amplifier, the first amplifier outputting a first amplified signal to a first output unit to visually output a sound level, the first amplified signal being controlled by a first potentiometer, a second component comprising a first microphone connected to a second amplifier, the second amplifier outputting a second amplified signal to a second output unit to visually output a sound level, the second amplified signal being controlled by a second potentiometer, wherein the first microphone and the second microphone are arranged on the device to pick up sound from different directions.

The above aspect can also be obtained by a method to detect audio properties in a room, the method comprising, providing a detection device, the detection device comprising an amplifier amplifying an audio signal into an amplified signal, a potentiometer controlling a strength of the amplified signal, a decoder outputting the amplified signal to an output device, activating the detection device, adjusting, by a user, the potentiometer so that the output device on the detection device shows a baseline level, and waiting and observing the output device.

### BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1A is a is a block diagram illustrating exemplary hardware for an audio detection system, according to an embodiment;

FIG. 1B is a drawing of a visual output device for an audio detection system, according to an embodiment;

FIG. 2 is a flowchart illustrating a method to detect audio signals, according to an embodiment;

FIG. 3 is a set of graphs illustrating an audio detection system/method, according to an embodiment;

FIG. 4A depicts a perspective partial cut away view of an audio detection system, according to an embodiment;

FIG. 4B depicts a perspective view of an audio detection system connected to an audio recording device, according to an embodiment;

FIG. 5 depicts alternate forms of the audio detection system, including one comprising multiple electronic circuits of FIG. 1 as well as different enclosures in which the same electronics can be utilized, including a crystal ball with illuminated display and a candlestick with illuminated display in LED flame, according to an embodiment; and

FIG. 6A is a block diagram showing hardware that can be used with the embodiment illustrated in FIG. 5, item 114.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Reference will now be made in detail to the presently preferred embodiments of the invention, examples of which are illustrated in the accompanying drawings, wherein like reference numerals refer to like elements throughout.

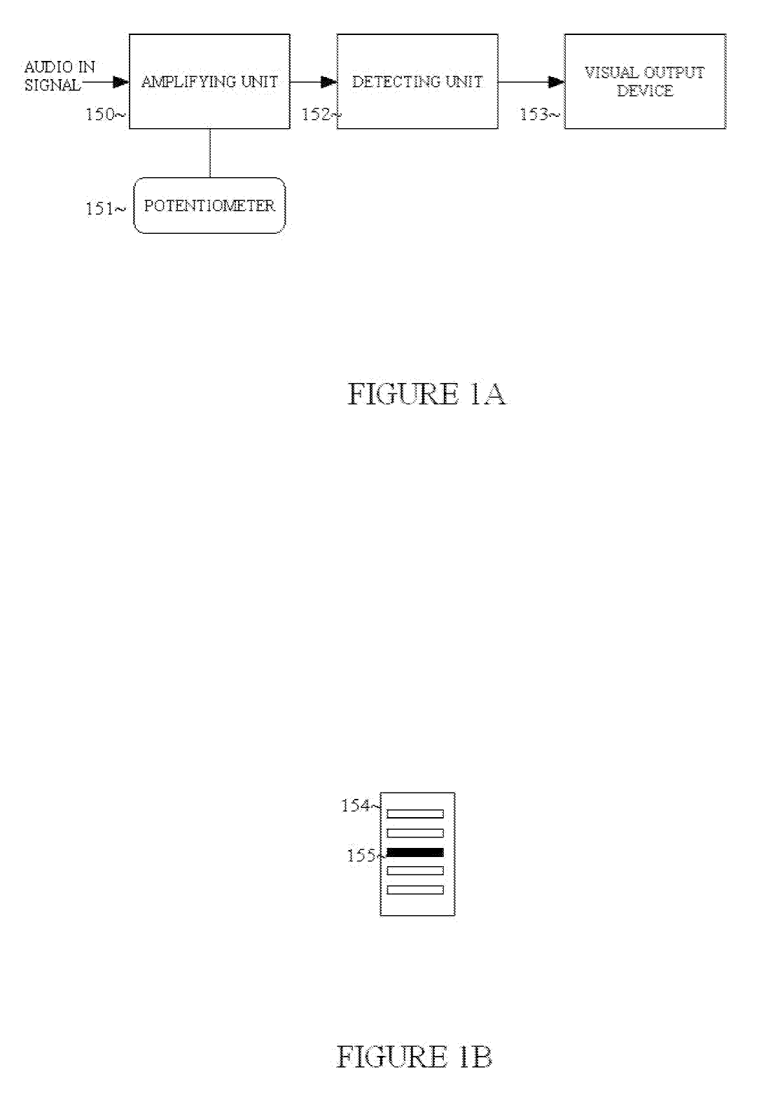

FIG. 1A is a block diagram illustrating exemplary hardware for an audio detection system, according to an embodiment.

An audio in signal is connected to an amplifying unit 150, using typical audio wires/connectors known in the art. The audio in signal can be the output signal from a handheld electrical device such as a tape recorder/player, microphone, MP3 player, or any electronic device that comprises an audio output. The audio in signal can also come from microphone that is integrated into the hardware illustrated in FIG. 1A. While not pictured, a headphone jack can be connected to the audio in jack, which allows a user to listen to the audio in signal, however, this does affect the operation of the device in any other way as the audio in signal is still processed as described herein.

The amplifying unit 150 comprises an amplifier to amplify the audio in signal. The amplifying unit 150 comprises a potentiometer 151 (or other analog or digital selection device) that sets an amplification level of the amplifying unit. The potentiometer can be controlled by thumb wheel that can be turned by a user.

Output from the amplifying unit 150 goes to a detecting unit 152. The detecting unit 152 analyzes the signal from the amplifying unit 150 and serves as a decoder/driver to send corresponding output to a visual output device 153.

The visual output device 153 can be for example a set of LEDs, digital readout, light bulb, or any other output device that can output to a user different levels so a user can discern which level is being output by inspection.

If the visual output device 153 is a set of LEDs (as illustrated in FIG. 1B), then the detecting unit 152 will light up a respective LED out of the set of LEDs which corresponds to an analog range of the signal outputted from the amplifying unit 150. Different LEDs will correspond to different currents (or power levels) coming out of the amplifying unit, and the detecting unit 152 determines which is the proper LED that corresponds to the current and then send current to the proper LED so it lights up.

The detecting unit 152 can be an analog or digital device/circuit. If digital, the detecting unit 152 can be analog to digital converter which converts the signal out of the amplifying unit 150 to a digital value, and then uses an IC to compare the value to a set of ranges and lights a particular LED which corresponds to that range using a multiplexer (or other structure).

Not pictured in FIG. 1A is a power supply and any other known components which may be needed to operate such a system.

FIG. 1B is a drawing of a visual output device for an audio detection system, according to an embodiment.

A set of LEDs 154 comprises five LEDs. A middle (or baseline) LED 155 is shown lit up. Each of the five LEDs corresponds to a different current (or power) level of the signal outputted by the amplifying unit. The potentiometer can be used to adjust the output so that the signal is displayed using the appropriate LEDs and the baseline is adjusted to illuminate the baseline LED.

This is just one example of a visual output device. For example, the device can have 9 LEDs (instead of 5) or any other number. The visual output device can be a digital readout, a light or LED (which changes intensity and/or color based on the level), or any other such output device.

For example, if the baseline LED 155 is lit, this would typically mean that there is no current noise in the room other than typical ambient noise. If the LEDs were numbered from 1 to 5, wherein 1 is the top LED, 2 is the next LED, 3 is the middle LED, 4 is the next LED, and 5 is the bottom LED, then if the top (LED 1) is lit then the audio signal entering the amplifying unit (which would typically be coming from a microphone in the room) contains a loud noise. If LED 2 is lit, then this would typically mean that there is a noise in the room but it is not as loud as if LED 1 was list but the noise is still louder than ambient noise. If LED 3 is lit, this indicates that the room is experiencing ambient noise but nothing else. If LED 4 is lit, this indicates that the noise level in the room is lower than the typical ambient noise level (baseline level). If LED is lit, this indicates that the noise level in the room is quieter than if LED 4 is lit and would typically indicate dead silence. Typically, when one LED is lit the other LEDs are off.

Note that ambient noise is not complete silence but only typical background noise that exists in a room. The user would use the potentiometer 151 to adjust the amplifier so that if there is only ambient noise in the room then the middle LED 155 (also known as baseline LED) is lit. In this manner, when noises occur that are louder than the ambient noise, then an LED higher than the middle LED 155 would light up. If the ambient noise in the room goes away, then an LED lower than the middle LED 155 would light up. Each LED has its own range of decibel levels. Another way to look at the LEDs is that the LEDs are in sequential order from quietest noise in the room to the loudest. Of course, instead of vertically, the LEDs could also be arranged horizontally, or in any other order. Alternatively, a digital readout could be used to display the sound level of the room (e.g., from 1 to 5 or other range).

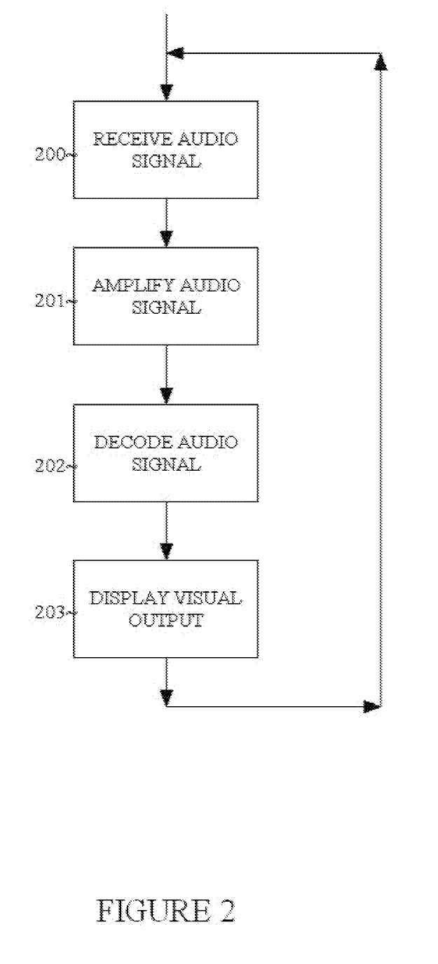

FIG. 2 is a flowchart illustrating a method to detect audio signals, according to an embodiment. The method illustrated in FIG. 2 is performed by the hardware illustrated in FIG. 1.

The method begins with operation 200, which receives an audio signal. An audio input jack can be located on the hardware in FIG. 1, and a user can plug a device into this jack which contains an audio signal. The audio signal can be from a tape (or MP3) recorder which uses a microphone to generate the audio signal and also records the signal simultaneously (on a tape, computer memory, or any other non-transitive storage medium).

From operation 200, the method proceeds to operation 201, which amplifies the audio signal. This can be done using an amplifier as known in the art. The level of amplification can be controlled by a controller (such as a thumb-wheel) which can control a potentiometer or other device which can adjust the level of amplification on the amplifier. Alternatively, the potentiometer can be used to adjust a reduction in the signal after leaving the amplifier.

From operation 201, the method proceeds to operation 202, which decodes the audio signal. The audio signal can be in a range of decibel levels, and different ranges of decibel levels would have different corresponding output mechanisms. For example, each range of decibel levels would have a corresponding LED that would light up if that decibel level were present in the audio signal. The decoding can be accomplished by using a digital IC or by using analog circuits (e.g., which can comprise resistors and diodes) to determine which LED should light up.

From operation 202, the method proceeds to operation 203, which displays the visual output decoded in operation 202. For example, this can comprise lighting up one of the respective LEDs on the visual output device.

Operations 200-203 will continue in an endless loop until the device is powered off.

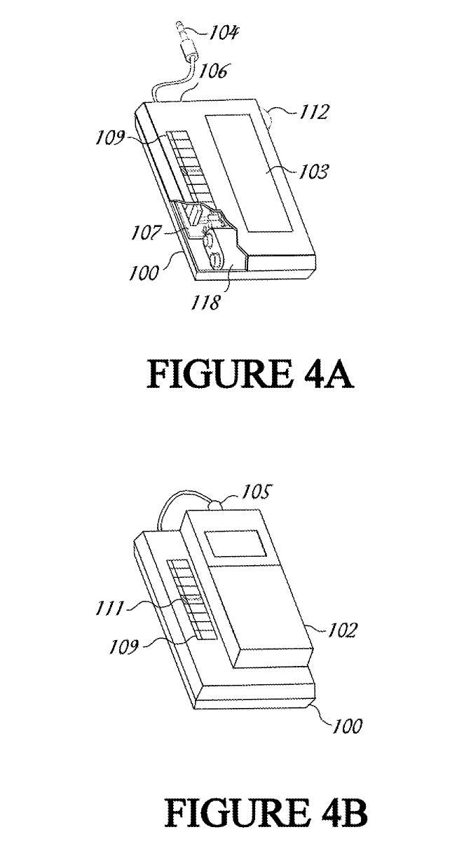

Thus, using the hardware illustrated in FIG. 1 and the method illustrated in FIG. 2, a sudden spike (or drop) in ambient noise in a room can be detected and visually indicated to a user. The user would turn on the device and adjust the potentiometer until the middle LED 111 shown in FIG. 4B lights up. Thus, for example, if the room is very quiet, then the user would increase the amplification on the amplifier using the potentiometer so that the middle LED 111 lights up. Additional noises in the room will be amplified and output on the display. If the room is very noisy, then the user would decrease the amplification on the amplifier using the potentiometer so that the middle LED 111 shown in FIG. 4B lights up. In this manner, whatever the level of ambient noise in a room is, it can be “equalized” using the potentiometer so that when the LEDs light up (other than the middle LED) it indicates a noise in the room (or a drop in the ambient noise in the room).

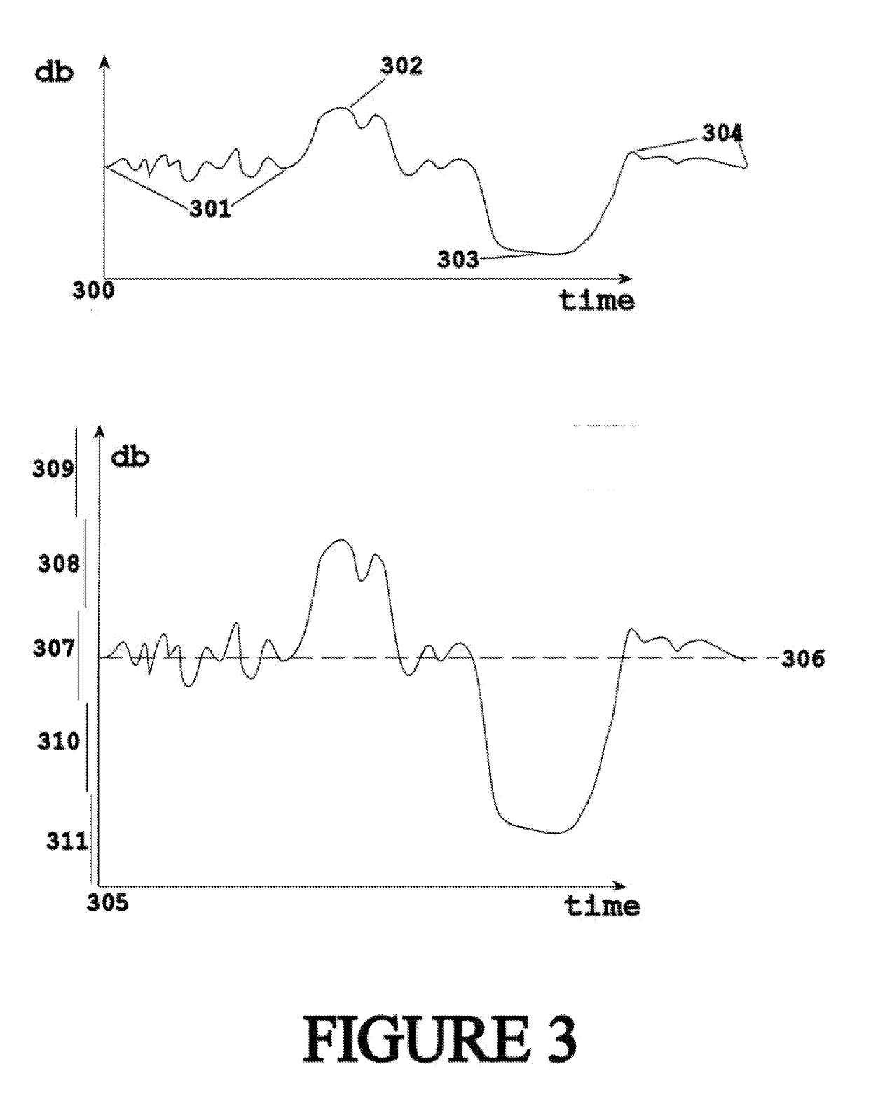

FIG. 3 is a set of graphs illustrating an audio detection system/method, according to an embodiment.

Initial graph 300 shows a graph of a decibel level (Y-Axis) charted vs. time (X-axis). A first ambient noise period 301 shows a period of ambient noise. A peak 302 shows a noise occurring. A valley 303 shows a period of silence which is quieter than the ambient noise periods 301, 304. Thus, during the valley 303, whatever the source of the ambient noise is has temporarily gone away, leaving the room very quiet. Sources of ambient noise can be, for example, cars, pedestrians, animals, wind, structural noises, etc. A second ambient noise period 304 occurs which is similar to the first period of ambient noise 301.

The peak 302 and valley 303 represent auditory events that are significant if a user is interested in detecting noise fluctuations from the ambient noise.

Second graph 305 shows the signal from initial graph 300 after passing through the amplifying unit 100 shown in FIG. 4A. The potentiometer can be adjusted by the user so that the ambient noise in the amplified signal is aligned with baseline 306. In other words, the baseline can be located at the average of the ambient noise periods. The user would typically adjust the potentiometer until the middle LED lights up and remains lit up.

Ranges 307, 308, 309, 310, 311 represent decibel ranges that correspond to individual LEDs. Range 307 corresponds to the middle LED (LED 3) in FIG. 1B. Thus, when the decibel level in the second graph 305 falls within range 307, then the middle LED on the output device would light up. Range 308 corresponds to LED 2, range 309 corresponds to LED 1, range 310 corresponds to LED 4, and range 311 corresponds to LED 5.

Thus, during the first ambient noise period 301, LED 3 would bet lit up. When the peak 302 occurs, when the decibel level goes from range 307 to range 308 LED 3 would turn off and LED 2 would light up. When the decibel level goes back from range 308 to range 307, then LED 3 would light up and LED 2 would turn off. During the valley 303, LED 3 would turn off and LED 4 would light up, and then LED 4 would turn off and LED 5 would turn on, and then LED 4 would turn on and LED 5 would turn off, and then when the decibel level returns to the second ambient noise period 304 LED 4 would turn off and LED 3 would light up.

It is further noted that instead of using LEDs corresponding to discrete ranges of decibel values, an analog output device (such as a needle) can be used as well. In this embodiment, a needle can serve as a meter regarding the output from the amplifying unit.

FIG. 4A depicts a perspective partial cut away view of an audio detection system 100, according to an embodiment.

The audio detection device 100 depicted in FIG. 4A is an embodiment of the device described in FIG. 1A described above. The audio input can be provided through an input jack 104, which can be connected to any external device (not pictured) capable of detecting or playing an audio signal. A strip of Velcro, double stick tape or the like 103, can allow the audio detection device 100 to be attached to an external device capable of detecting or playing an audio signal. A small battery 118 can be used to power the device 100 and it can comprise an adjustable potentiometer 112, a circuit board 107 and an LED display 109.

FIG. 4B depicts a perspective view of an audio detection system 100 connected to an external device 102 capable of detecting or playing an audio signal, according to an embodiment.

In a preferred embodiment, the external device 102 can be an audio recorder such as a tape recorder or similar device, which can comprise an internal microphone (not pictured). Audio signal can be delivered from an output jack 105 on the external device 102 to the input of the audio detection system 100. Once sound has been interrupted into the audio detection system, a baseline can be set, which illuminates a predetermined LED 111 comprising the LED display 109.

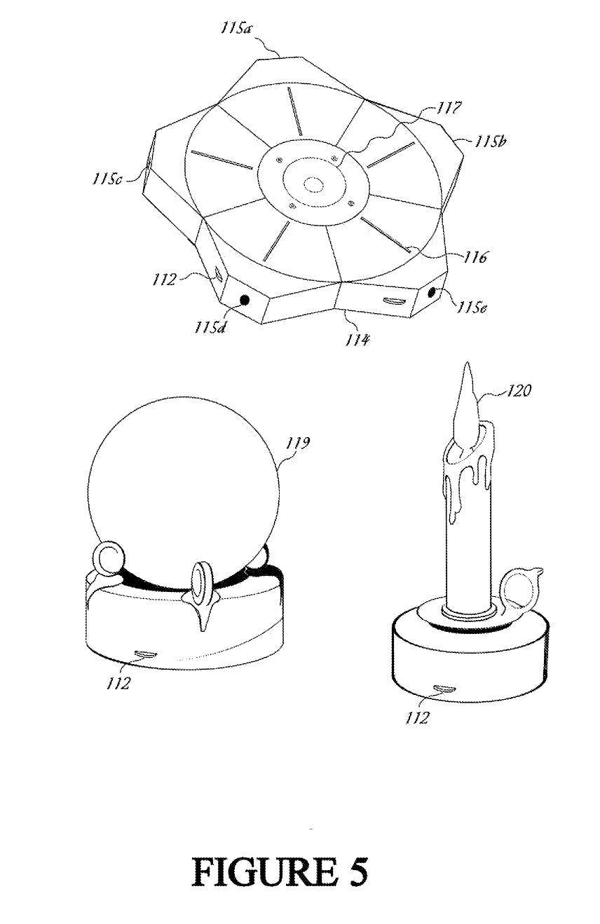

FIG. 5 depicts alternate forms of the audio detection system, including one 114 comprising multiple electronic circuits of FIG. 1 as well as different enclosures in which the same electronics can be utilized, including a crystal ball 119 with illuminated display and a candlestick 120 with illuminated display in LED flame, according to an embodiment.

Each of the three embodiments depicted in FIG. 5 can comprise potentiometers 112 and the multidirectional configuration 114 can comprise multiple potentiometers. In a crystal ball 119, and candlestick 120 embodiments the illuminated displays can comprise LEDs of three different colors. One color can indicate that the detected audio is at the baseline level, a second color can indicate that detected audio is above a baseline level and a third color can indicate that detected audio is below a baseline level.

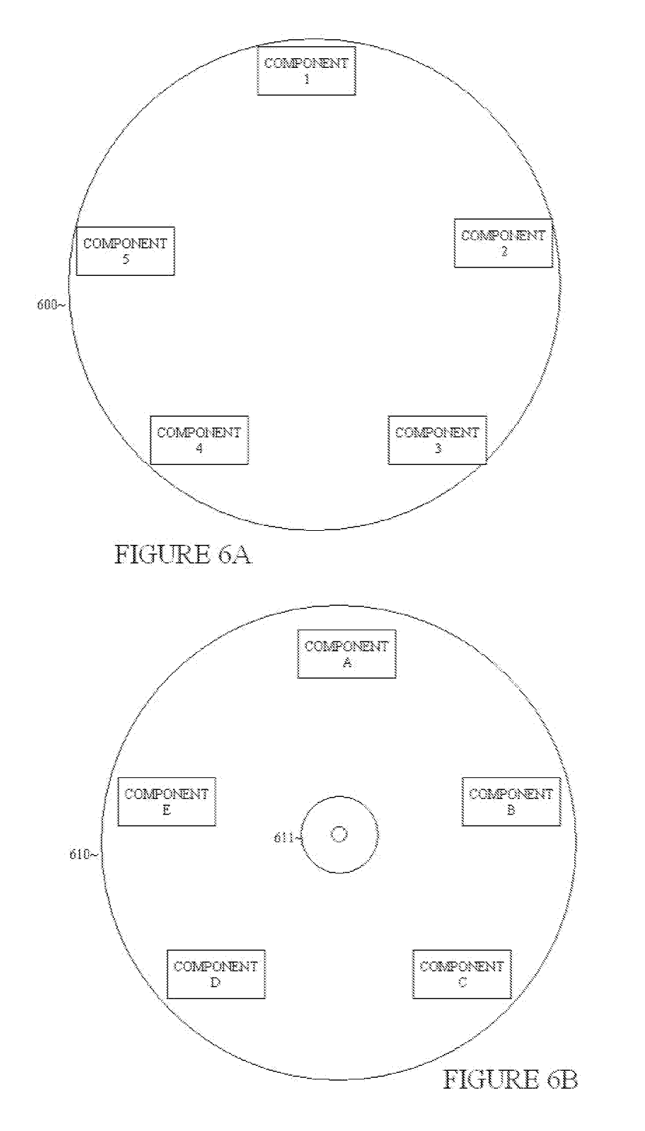

FIG. 6A is a block diagram showing hardware that can be used with the embodiment illustrated in FIG. 5, item 114.

In this embodiment 600, five (or any other number) sets of components can be combined to provide directional information to the user. Each component's (1, 2, 3, 4, 5) can be the entire set of hardware illustrated in FIG. 1A. Thus, this embodiment combines five separate sets of the hardware illustrated in FIG. 1A all arranged substantially in a circle. The audio in signal is a supplied by a microphone (from FIG. 5) 115a, 115b, 115c, 115d, 115e, which then connects to each component's amplifying unit. The potentiometer 112 (from FIG. 5) for each component is a thumb wheel. The visual output device for each component is the LEDs 116 from FIG. 5. Each component operates independently and has its own power source (or alternatively shares a single power source and/or a single potentiometer).

In this embodiment, since there are five LEDs arranged around a circle, by visually inspecting the entire device a user can see which direction a sound (or silence below the ambient sound level) is coming from.

FIG. 6B is a block diagram showing another set of hardware that can be used with the embodiment illustrated in FIG. 5, item 114.

A second embodiment 610 using the structure illustrated in FIG. 5 is similar to the prior embodiment 600 but a speaker 611 is located in a center of the device. The microphones for each component can be positioned away from the speaker so that each microphone would equally pick up sound emanating from the speaker 611.

The speaker can be located in a center of the device 610 and broadcast white noise. Each component A, B, C, D, E picks up the sound from the speaker 611 and each respective LED from each component A, B, C, D, E will reflect the respective component's signal accordingly. Each component has its own potentiometer (or can share a potentiometer) which would adjust each component (as in embodiment 600) by the user to typically adjust each component to the room's ambient noise level.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An audio detection system comprising:
an audio input device;
an amplifying unit comprising a potentiometer configured to set a baseline;
a detecting unit configured to detect audio input above the baseline and audio input below the baseline; and
a visual output device configured to display a baseline and audio input above the baseline and audio input below the baseline.

2. An audio detection system as described in claim 1 wherein the audio input device is an external microphone connected to the amplifying unit through a jack.

3. An audio detection system as described in claim 1 wherein the audio input device comprises an internal microphone.

4. An audio detection system as described in claim 3 wherein the audio input device is a voice recorder.

5. An audio detection system as described in claim 1 wherein the potentiometer is configured to automatically set a baseline.

6. An audio detection system as described in claim 1 wherein the potentiometer is configured to manually set a baseline.

7. An audio detection system as described in claim 1 also comprising an audio output jack.

8. An audio detection system as described in claim 1 also comprising a white noise generator.

9. An audio detection system as described in claim 1 wherein the visual output device is an analog moving coil display.

10. An audio detection system as described in claim 1 wherein the visual output device comprises one or more light-emitting diodes (LEDs).

11. An audio detection device, comprising:
a first component comprising a first microphone connected to a first amplifier, the first amplifier outputting a first amplified signal to a first output unit to visually output a sound level, the first amplified signal being controlled by a first potentiometer;
a second component comprising a first microphone connected to a second amplifier, the second amplifier outputting a second amplified signal to a second output unit to visually output a sound level, the second amplified signal being controlled by a second potentiometer;
wherein the first microphone and the second microphone are arranged on the device to pick up sound from different directions.

12. An audio detection system as described in claim 11 wherein the first and second potentiometers are configured to automatically set a baseline.

13. An audio detection system as described in claim 11 wherein the first and second potentiometers are manually adjusted to set a baseline.

14. An audio detection system as described in claim 11 also comprising a white noise generator.

15. An audio detection system as described in claim 10 wherein the first and second output units comprise one or more light-emitting diodes (LEDs).

16. A method to detect audio properties in a room, the method comprising:
providing a detection device, the detection device comprising:
an amplifier amplifying an audio signal into an amplified signal;
a potentiometer controlling a strength of the amplified signal;
a decoder outputting the amplified signal to an output device;
activating the detection device;
adjusting, by a user, the potentiometer so that the output device on the detection device shows a baseline level; and
waiting and observing the output device.

17. The method as recited in claim 16, wherein the potentiometer controls the amplifier.

18. The method as recited in claim 16, wherein the potentiometer is used to adjust the strength of the amplified signal after the amplified signal has left the amplifier.

19. The method as recited in claim 16, wherein the output device comprises a set of LEDs.

20. The method as recited in claim 19, wherein the adjusting comprises the user adjusting the potentiometer so that the output device lights up a middle LED in the set of LEDs.
